(19) United States
(12) Patent Application Publication
(10) Pub. No.: US 2012/0313942 A1
(43) Pub. Date: Dec. 13, 2012

(54) SYSTEM AND METHOD FOR DIGITAL VOLUME PROCESSING WITH GPU ACCELERATIONS

(75) Inventor: Shoupu Chen, Rochester, NY (US)

(73) Assignee: Carestream Health, Inc.

(21) Appl. No.: 13/421,183

(22) Filed: Mar. 15, 2012

Related U.S. Application Data
(63) Continuation-in-part of application No. 13/156,378, filed on Jun. 9, 2011.

(51) Int. Cl. G06T 17/00

(52) U.S. Cl. 345/424

(57) ABSTRACT

A method for processing digital volume image data, executed at least in part on a computer that has an associated graphics processing unit, orders the digital volume image data as a stack of two-dimensional image slices of voxels. A 1:1 mapping of each of the slices is formed, in sequential order, to a corresponding tile in a digital one-row flat volume in a global memory. For each voxel in the digital flat volume, a neighborhood is defined that has, relative to each voxel, four or more adjacent voxels that are within the corresponding tile of each voxel, and one or more adjacent voxels that are within the preceding tile, and one or more adjacent voxels that are within the next tile. Each voxel is updated according to information stored for the adjacent voxels in the defined neighborhood for said each voxel to form a rendered volume image, which is displayed.

### CROSS REFERENCE TO RELATED APPLICATIONS

This is a Continuation-in-Part of U.S. Ser. No. 13/156,378 titled SYSTEM AND METHOD FOR DIGITAL VOLUME PROCESSING filed on Jun. 9, 2011 in the names of Li et al.

### FIELD OF THE INVENTION

The invention relates generally to processing of digital volume images, and in particular, to a system and methods for improved high-speed processing of digital volume images using a CUDA (Compute Unified Device Architecture) enabled GPU (graphics processing unit).

### BACKGROUND OF THE INVENTION

3-D volume imaging has proved to be a valuable diagnostic tool that offers significant advantages over earlier 2-D radiographic imaging techniques for evaluating the condition of internal structures and organs. 3-D imaging of a patient or other subject has been made possible by a number of advancements, including the development of high-speed imaging detectors, such as digital radiography (DR) detectors that enable multiple images to be taken in rapid succession. Digital volume images, obtained from computed tomography (CT) or other imaging systems, provide valuable tools for diagnosis, treatment planning, and biomedical modeling and visualization.

While it may offer some benefits, 3-D volume imaging works with large amounts of data and requires considerable data processing resources, with very high CPU usage and long processing times. Image processing utilities for 3-D volume imaging include processes such as volume segmentation, a process that partitions a three-dimensional image set into a plurality of non-overlap regions. As an example of a segmentation process, the GrowCut segmentation algorithm (see “GrowCut—Interactive Multi-Label N-D Image Segmentation By Cellular Automata,” by Vladimir Vezhnevets, and Fadim Konouchine, International Conf. Computer Graphics and Vision 2005) stores at least five intermediate three-dimensional image sets in order to perform its segmentation processing. With this much data to process, computation cost is often a concern and the CPU (central processing unit) based GrowCut algorithm takes a very long time to compute. For a medium size volume data set (e.g.181×147×242 voxels), the execution time using GrowCut segmentation is about 15 minutes using a capable CPU processor (e.g. an Intel® Core™ 2 Duo CPU) with sequential processing.

One solution proposed for processing the massive amounts of data needed to support functions such as image segmentation is the use of a dedicated Graphical Processing Unit (GPU). Originally developed for computer game and simulation applications, the GPU has evolved from a dedicated graphic display processor with a fixed pipeline to a more capable processor for general purpose computing, matrix computing, image processing, simulation and medical imaging using parallel processing with the programming pipeline. GPU architecture and its parallel processing capabilities have been utilized for providing hardware-accelerated volume image rendering of CT and other images, as described in U.S. Patent Application No. 2006/0227131 entitled “Flat Texture Volume Rendering” by Schiwietz et al. This approach stores the 3D image slices as flat texture data. While such a method improves some aspects of image storage and addressing, however, it does not facilitate update of the volume image data and has other drawbacks. Storage of 3D image data slices as flat texture structures makes it cumbersome to apply processing that updates image data elements, such as bilinear filtering, for example, that require facile computation between neighboring voxels. Addressing problems with GPU hardware become considerably more complex than with conventional CPU structures. In order to find neighbors for a voxel, for example, it is necessary to calculate and keep track of the tile offsets in the flat volume. Such calculations, since they are required for every voxel in the GPU shader program, can slow shader performance considerably. It appears that, because of the complexity and time required for addressing neighboring voxels, methods such as that taught in Schiwietz et al. '7131 are not well suited to support segmentation, such as using the GrowCut algorithm noted earlier.

While GPU capabilities offer some promise for improving processing speed and capability overall, a number of significant problems remain. GPU programming is not straightforward and requires different strategies for data storage and addressing than those conventionally applied for central processing unit (CPU) schemes.

Thus it is seen that, while GPU capabilities offer an attractive alternative to conventional CPU-based image processing for volume images, there is considerable work needed to take advantage of GPU parallel processing capabilities. One aspect of this problem relates to the task of mapping the existing volume image data structures into a form that can be readily handled by the GPU and to addressing schemes needed to harness the capability of the GPU for high-level image processing such as registration, filtering, and segmentation.

### SUMMARY OF THE INVENTION

It is an object of the present invention to advance the art of volume image processing using GPU-based technology. The present invention provides methods that help to streamline and simplify the problem of voxel addressing needed to obtain information from neighboring voxels for each voxel in a volume image.

An advantage of the present invention relates to the ease of indexing between slices of the image when the image data is arranged in a GPU flat volume data structure.

According to an aspect of the present invention, there is provided a method for processing digital volume image data, the method executed at least in part on a computer that has an associated graphics processing unit, the method comprising: ordering the digital volume image data as a stack of two-dimensional image slices, each slice containing a plurality of voxels; forming a 1:1 mapping of each of the slices, in sequential order, to a corresponding tile in a digital one-row flat volume in a global memory of the graphics processing unit; defining, for each voxel of a plurality of voxels in the digital flat volume, a neighborhood that comprises, relative to said each voxel, four or more adjacent voxels that are within the corresponding tile of said each voxel, and one or more adjacent voxels that are within the preceding tile, and one or more adjacent voxels that are within the next tile; updating said each voxel according to information stored for the adjacent voxels in the defined neighborhood for said each voxel to form a rendered volume image; and displaying the updated rendered volume image.

### BRIEF DESCRIPTION OF THE DRAWINGS

The foregoing and other objects, features, and advantages of the invention will be apparent from the following more particular description of the embodiments of the invention, as illustrated in the accompanying drawings, in which:

FIG. 1A is a schematic diagram that shows a pixel and its neighbors in a 2-dimensional image arrangement.

FIG. 1B is a schematic diagram that shows a voxel and its neighbors in a 3-dimensional image arrangement.

FIG. 1C is a schematic block diagram that shows parts of a volume image processing apparatus according to an embodiment of the present invention.

FIG. 2A is a diagram that shows a representative volume image having eight slices.

FIG. 2B is a diagram that shows the slices of the volume image in FIG. 2A represented as tiles in a flat volume for GPU processing.

FIG. 2C is a diagram that shows an index variable k assignment for slices in the volume image, as used in a neighbor-order rendering scheme, according to an embodiment of the present invention.

FIGS. 2D, 2E, and 2F show the use of an index variable z for selecting the direction of referencing in neighbor-order rendering.

FIG. 3A is a logic flow diagram that shows the overall sequence of steps for processing a volume image using the graphics processing unit.

FIG. 3B is a logic flow diagram that shows the GPU data processing loop for current, preceding, and next slices.

FIG. 4 is a logic flow diagram that shows steps for obtaining the address of neighboring voxels.

FIG. 5 is a schematic diagram showing storage of a vector used for addressing.

FIG. 6 is a logic flow diagram that shows the sequence used for update of a voxel in neighbor-order rendering.

FIG. 7A is a diagram that shows the mapping scheme for adjacent voxels according to an embodiment of the present invention.

FIG. 7B is a table that shows addressing offsets for addressing neighboring voxels using the arrangement of FIG. 7A.

FIG. 8 is a logic flow diagram showing the update process for image voxels.

### DETAILED DESCRIPTION OF THE INVENTION

The following is a detailed description of the preferred embodiments of the invention, reference being made to the drawings in which the same reference numerals identify the same elements of structure in each of the several figures.

In the context of the present disclosure, the term “image” refers to multi-dimensional image data that is composed of discrete image elements. For 2-D images, the discrete image elements are picture elements, or pixels. For 3-D images, the discrete image elements are volume image elements, or voxels.

In the context of the present disclosure, the terms “tile” and slice are interchangeable, describing the same image content, in 2-D form, from different aspects. The term “texture” defines a variable-length data structure used in GPU data representation, familiar to those skilled in GPU programming. The texture is typically a 1-, 2-, or 3-dimension array, optimized to support parallel processing by the GPU. Textures can be readable and writable. In GPU image processing, the texture image elements can store information such as voxel color and intensity. A “shader” is a GPU program that is designed to operate efficiently on the texture data structure to support parallel processing of the image data. Rendering of processed data can be directed to a texture, for example.

In the context of the present disclosure, the terms “neighboring voxel” and “adjacent voxel” are considered to be synonymous. Voxel update is required as a result of some type of image processing, such as segmentation or applying a filter to the image data, for example.

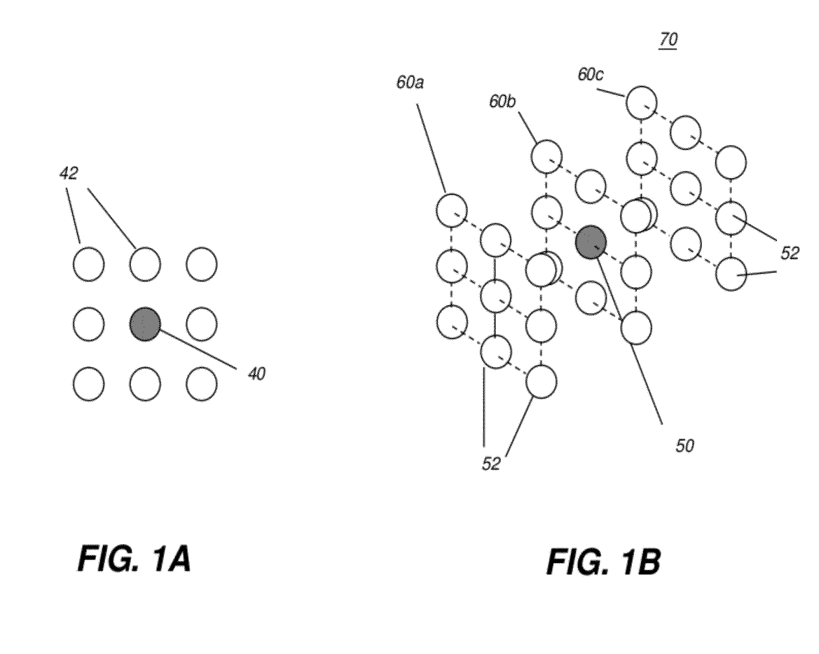

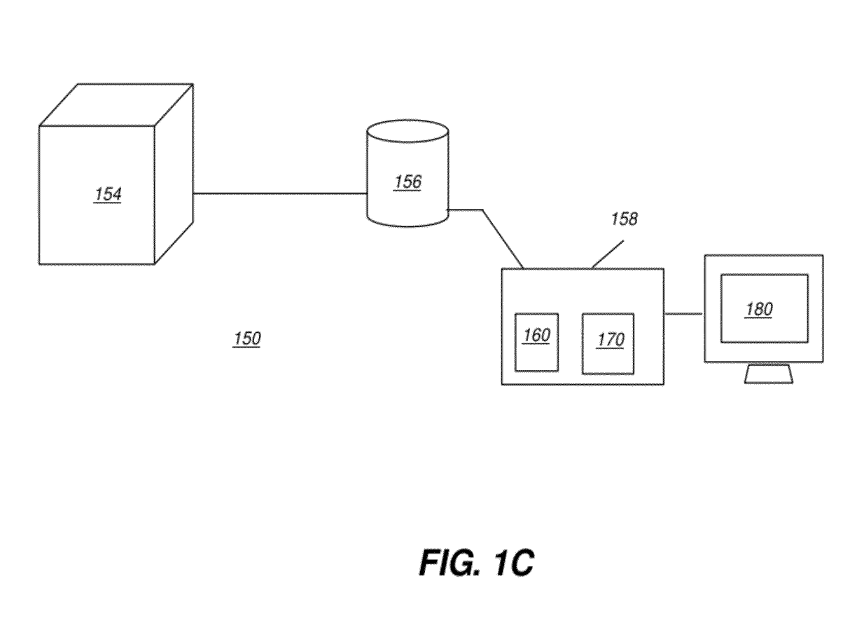

Segmentation, filtering, and other image processing functions for volume images typically require calculations that address each voxel and its surrounding neighbors or adjacent voxels. In 2D image processing, similar types of operations are carried out for individual pixels, with each individual pixel having 8 neighboring pixels. By way of reference, FIG. 1A shows a pixel 40 surrounded by its 8 neighboring pixels 42.

For a volume image, as shown for reference in FIG. 1B, a neighborhood 70 is far more complex, formed of adjacent voxels and spanning multiple slices. Information must propagate in multiple directions, not only within a slice (intra-slice), but between slices (inter-slice). In the example given in FIG. 1B, a voxel 50 in a slice 60b has 26 neighboring or adjacent voxels 52. Eight of these voxels are within its own slice, as was shown for pixel 40 in FIG. 1A. In the embodiment shown, adjacent neighboring voxels are defined to be those that are less than 2 times the distance of the nearest neighboring voxel, considered in any axial direction. In addition, it is noted that some other fixed distance could be used to determine which voxels can be considered to be adjacent. For the FIG. 1B example, in addition to the eight voxels on its own slice 60b, nine additional voxels are adjacent on a preceding slice 60a; nine more voxels are similarly adjacent on a subsequent or next slice 60c. Given this added complexity with three dimensions for volume imaging, it can be appreciated that, because neighboring voxels are on different slices, voxel addressing becomes significantly more difficult than in the 2D case. This complexity increases further when the fixed distance that defines adjacence is increased so that, for a subject voxel, more than 8 voxels are adjacent on its own slice 60b and more than 9 voxels may be adjacent in each of neighboring slices 60a and 60c. In addition, this model for defining neighborhood 70 can be expanded to further include voxels that are spaced two tiles away in the previous and next directions, for example.

FIG. 1C is a schematic block diagram that shows parts of a volume image processing apparatus 150 according to an embodiment of the present invention. A volume imaging apparatus 154, such as a CT imaging apparatus, obtains the volume image of a patient or other subject as image data. A computer-accessible memory 156 stores the obtained volume image data for subsequent processing and display. A computer 158 accesses memory 156 in order to access and process the volume image data. Computer 158 has a control processing unit (CPU) 160 for handling overall logic and control functions for image processing apparatus 150. In addition, computer 158 also has a Graphics Processing Unit (GPU) 170 that provides improved processing for volume imaging. A display 180, such as a conventional, high-resolution display monitor, for example, is used to display the processing results for a medical practitioner or other viewer.

Embodiments of the present invention use the GPU 170 for high speed digital volume processing to support segmentation and other complex operations. A novel addressing scheme, termed neighbor-order rendering, allows quick access to data about neighboring voxels on different slices to facilitate the computation needed for segmentation, filtering, and other compute-intensive volume image processing operations.

### Mapping Scheme

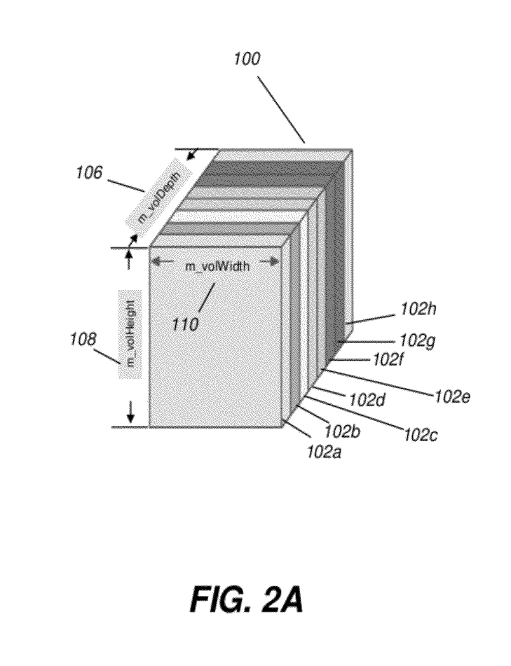

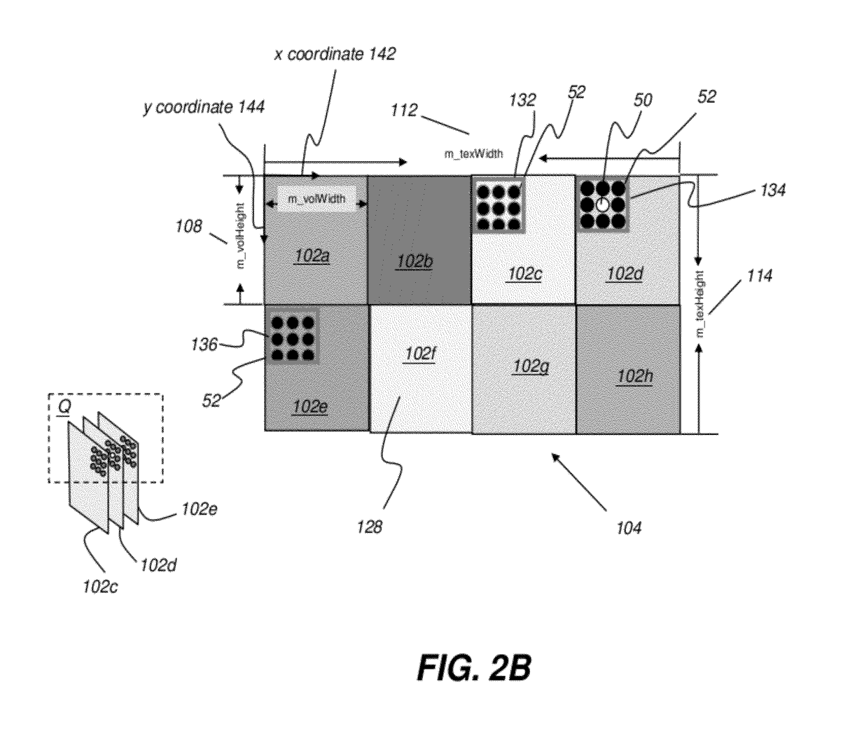

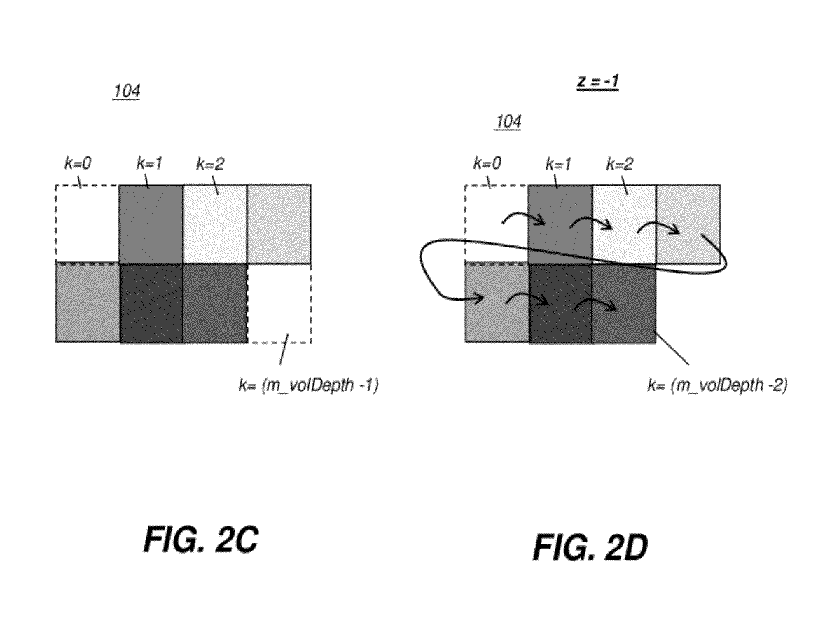

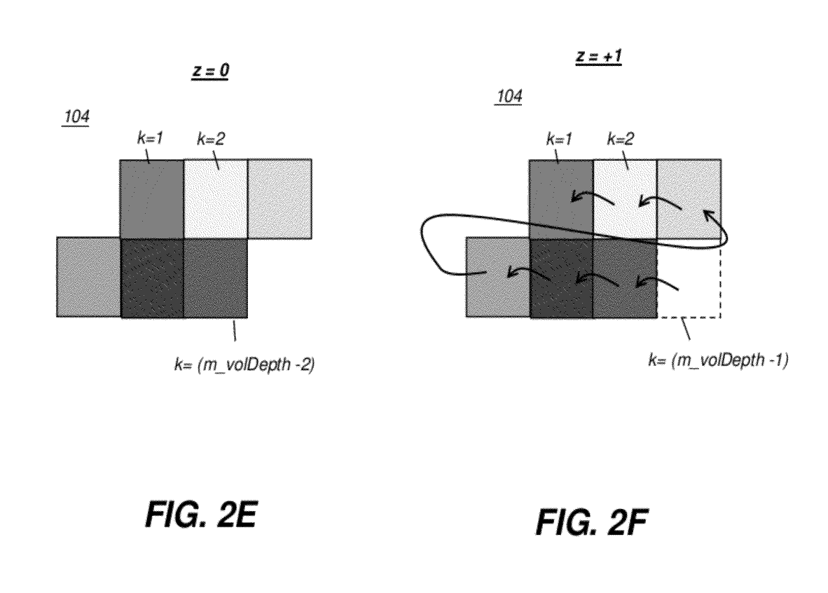

By way of illustration, FIG. 2A shows a simplified model volume 100 that has only eight slices, shown as 102a, 102b, 102c, 102d, 102e, 102f, 102g, 102h. Volume 100 has a depth 106, m_volDepth, with a value 8 that corresponds to the number of slices. Each slice has a height 108, m_volHeight, and a width 110, m_volWidth. Continuing with this eight-slice example, FIG. 2B shows how image slices 102a-102h are mapped to a GPU data structure, as a flat volume or 2D texture 104. 2D texture 104 stores slices 102a-102h as “tiles”. This is a 1:1 ordered mapping, so that image slice 1 maps to tile 1, slice 2 to maps to tile 2, and generally slice n maps to tile n. An inset Q shows how voxels in slices 102c, 102d, and 102e relate to each other spatially in a volume arrangement. As noted previously, the terms “slice” and “tile” are used equivalently herein to describe the same structure in the context of the present disclosure.

The use of a flat volume has been proposed for image data representation in GPU processing in a number of different applications. One example application is described in the article “Simulation of Cloud Dynamics on Graphics Hardware” by Harris, Baxter, Scheuermann, Lastra, Proc. Graphics Hardware 2003, Eurographics Association, pp. 92-101. The use of a flat volume offers some advantages over more conventional 3D volume texture. For example, only one texture update is needed per operation and GPU parallelism is used efficiently. Schiwietz et al. '7131 also teaches a method of flat texture rendering for volume imaging. However, as noted earlier, it is necessary to calculate tile offsets in the flat volume in order to address neighbors for a voxel. This type of calculation, required for every voxel in the GPU shader program, necessitates multiple computations for update of each voxel, and can degrade shader performance. This, in turn, hampers the performance of the GPU for volume image processing applications.

In the flat volume or 2D texture of FIG. 2B, dimensions m_vo/Width and m_volHeight are shown for slice 102a. A texture width 112 is shown as m_texWidth and is equal to:

m_texWidth=(m_volWidth)*(m_tileCol)

wherein m_tileCol is the number of tiles (slices in a row). In the current example, m_tileCol=4.

A texture height 114 is shown as m_texHeight. The texture height 112, m_texHeight of texture 104 equals:

m_texHeight=(m_volHeight)*(m_tileRow)

wherein m_tileRow is the number of rows of tiles in the 2D texture presentation. In the current example, m_tileRow=2.

To use the GrowCut algorithm or other type of processing using the mapped arrangement of FIG. 2B, an individual voxel's status (that is, its strength and label values) is updated based, at least in part, on its neighbors' status (strength and label values). As was shown in FIG. 1B, each voxel 50 has 26 neighboring or adjacent voxels in the 3D volume, including 9 adjacent voxels 52 on the preceding or previous slice and 9 adjacent voxels on the subsequent or next slice. In FIG. 2B, exemplary voxel 50 under consideration is shown as a white dot in a current slice 102d. The eight neighboring or adjacent voxels 52 in that same slice are shown as dark dots in slice 102d and constitute a current neighborhood layer 134; with respect to FIG. 1B, these correspond to voxels 52 in slice 60b. At least four adjacent voxels 52 in the same slice are used as neighbors to form the current neighborhood layer, thus providing at least “4-connectivity” within the current neighborhood layer. The preceding or previous tile or slice 102c has nine neighboring or adjacent voxels 52, also shown as dark dots. These adjacent voxels constitute a preceding neighborhood layer 132; with respect to FIG. 1B, correspond to voxels 52 in slice 60a. The next tile or slice 102e similarly has nine neighboring or adjacent voxels 52, also shown as dark dots. These constitute a next neighborhood layer 136 for voxel 50; with respect to FIG. 1B, these correspond to voxels 52 in slice 60c.

As shown in FIG. 2B, there is a tile_x coordinate 142 and tile_y coordinate 144 that provide the coordinate axis system for the 2D texture 104. The origin is the upper left tile, slice 102a, in the 2D texture 104. For an arbitrary tile (or slice) in 2D texture 104, the tile_x and tile_y positions (or offset) for the tile can be computed as:

sliceX=k % m_tileCol

wherein sliceX is the starting tile_x coordinate for the tile, “%” is a modulus operator, and kε[0, m_volDepth−1];

sliceY=k/m_tileCol

where sliceY is the starting tile_y coordinate for said tile, “/” is an integer division operator (fractional component discarded), and kε[0, m_volDepth−1].

For the exemplary 8-tile (slice) flat volume of FIGS. 2A and 2B, m_volDepth=8. For an exemplary tile 128, k=5 and m_tileCol=4, therefore:

sliceX=5%4=1

sliceY=5/4=1

As shown in FIG. 2B, the x-y coordinate system (x coordinate 142, y coordinate 144) for the 2D texture 104 has its origin at the upper left corner of the 2D texture 104. For an arbitrary tile (or slice) in the 2D texture 104 shown in FIG. 2B, the starting x-y coordinate positions (or offset) for the tile can be computed as follows:

x1=sliceX*m_volWidth,

y1=sliceY*m_volHeight

wherein, for a tile x1 is the starting x coordinate and y1 is the starting y coordinate.

FIGS. 2C, 2D, 2E, and 2F show how the flat volume mapping scheme of the present invention relates voxels in adjacent slices or tiles for rendering, and show how this scheme handles border conditions. For a pixel at a first coordinate in a subject tile, there is a next adjacent pixel at the same first coordinate in the next tile. Similarly, for a pixel at the first coordinate in a subject tile, there is a previous or preceding adjacent pixel at the same first coordinate in the preceding tile. In addition, these figures also show how variables described in subsequent processing steps are used. FIG. 2C shows how variable k is assigned for providing an index to each successive slice or tile. The first tile is assigned k=0 and is shown in dashed outline, since voxels within this tile are not rendered using neighbor-order rendering. This rendering exception is also true for voxels in the last tile, which is assigned the value k=(m_volDepth−1).

The value z is used for indexing from a tile to its preceding and next tiles in neighbor-order rendering. FIG. 2D shows how preceding tiles, when index z=−1, are used in this rendering scheme. Here, first tile k=0 plays a part in rendering voxels in tile k=1. Information related to voxels in tile k=1 is used to update voxels in tile k=2, and so on. The last tile is not used, since voxels in the k=(m_volDepth−1) tile are not rendered using this technique. FIG. 2E shows the case when z=0. Here, voxels in each of the tiles from k=1 through k=(m_volDepth−2) are updated using information from neighboring or adjacent voxels within the same tile. FIG. 2F shows the case when index z=+1. Here, first tile k=0 plays no part in the rendering scheme, but last tile k=(m_volDepth−1) does, since data from each next tile is used for the current tile. The information used from each adjacent voxel can include any of the values that are stored for that voxel, generally termed voxel status, and including any applicable values such as its intensity value or other data values, for example.

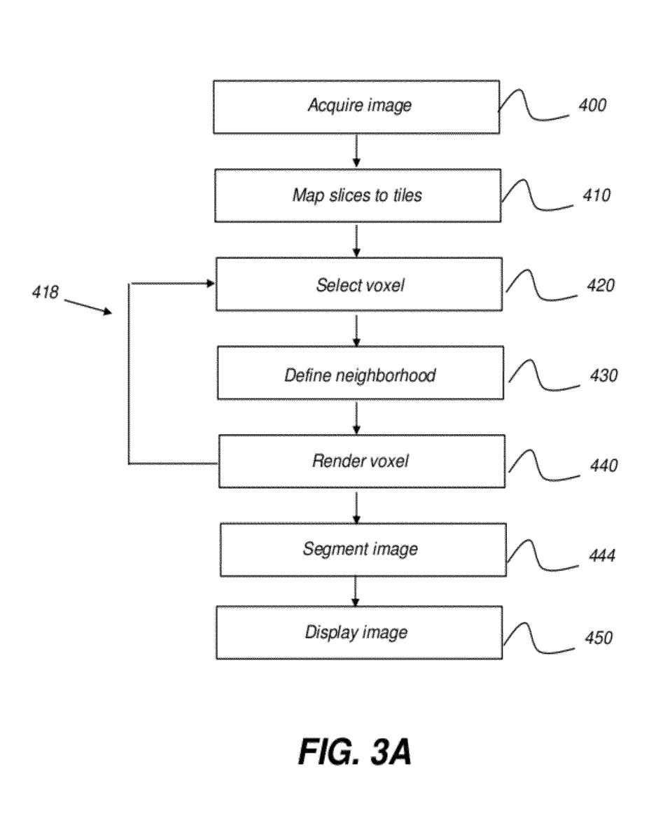

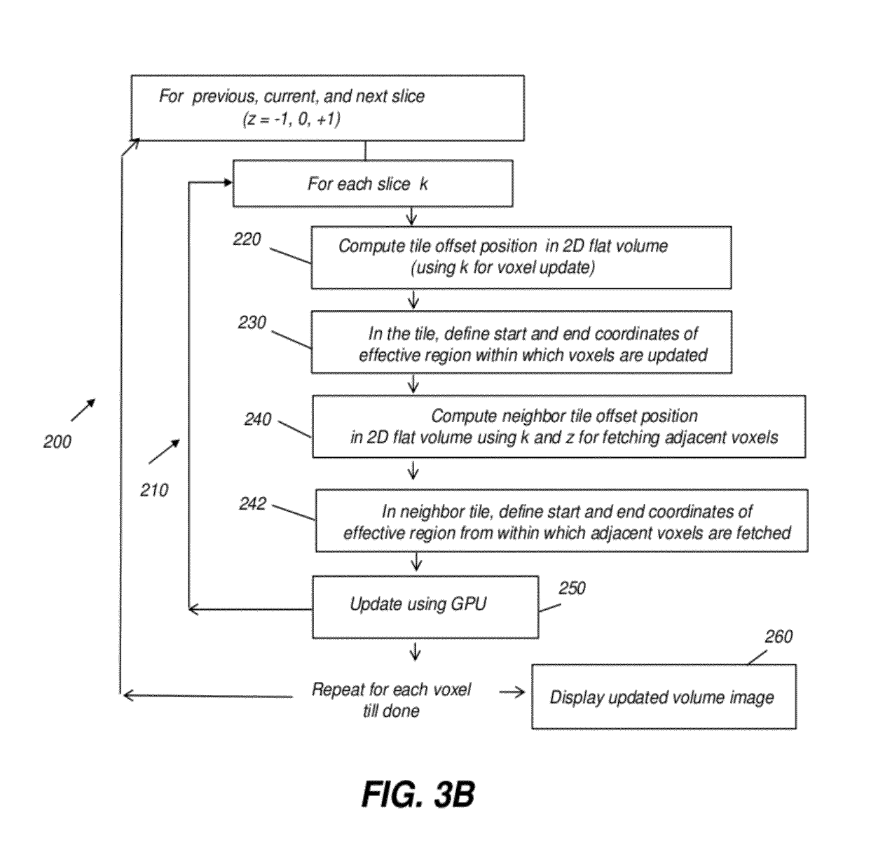

The logic flow diagram of FIG. 3A shows the overall sequence of steps for processing a volume image using the graphics processing unit. In an image acquisition step 400, the volume image data is acquired for processing, ordered as a stack of two-dimensional image slices. A mapping step 410 then forms a 1:1 mapping of the volume image data slices to corresponding tiles in the GPU digital flat volume, stored in a global memory associated with the graphics processing unit. A loop 418 then executes for each voxel, with a voxel selection step 420 to specify the subject voxel for processing. A neighborhood definition step 430 defines the neighborhood that includes the subject voxel and adjacent voxels that are within the corresponding tile of the subject voxel, and adjacent voxels to the subject voxel that are within the preceding tile in the digital flat volume, and adjacent voxels to the subject voxel that are within the next tile in the digital flat volume. The subject voxel is then rendered (or updated) by fetching neighbor information in a rendering step 440, one layer at a time (e.g., where the layer is a preceding neighborhood layer 132, current neighborhood layer 134 with a minimum of 4-connectivity, or next neighborhood layer 136). An optional segmentation step 444 can then be used to segment the image, using the GrowCut algorithm or other suitable segmentation algorithm. Finally, when all voxels have been suitably processed, the volume image is displayed in a display step 450.

Using the arrangement and definitions described with reference to FIGS. 2A through 2F, the logic flow diagram of FIG. 3B shows steps of a sequence that is used for addressing and processing each voxel in the volume image using GPU functions. In a first loop 200, preceding, current, and next index values, that is, the neighbor-order index z values, are successively assigned for handling voxel values in adjacent slices. As shown in FIG. 2D, value z=−1 is used as an index that corresponds to the preceding slice. As shown in FIG. 2E, index value z=0 corresponds to the current slice. As shown in FIG. 2F, index value z=+1 corresponds to the next slice. In an inner loop 210, each slice or tile is handled as part of the flat volume data structure described with reference to FIG. 2B.

By way of example, considering the FIG. 2B example for voxel 50 in slice 102d, when value z=−1, neighboring or adjacent voxels 52 in slice 102c are used in processing. When z=0, adjacent voxels 52 in slice 102d are addressed. When z=1, adjacent voxels 52 in slice 102e are addressed.

Continuing with the FIG. 3B sequence, a step 220 computes the tile offset position for the tile to be rendered in the 2D flat volume, corresponding to its k value in FIG. 2C. A definition step 230 defines start and end coordinates of an effective region for the subject voxel within a tile in the 2D flat volume for processing. To prevent boundary conditions, the start and end coordinates are stepped back an increment from the edge of the tile. A computation step 240 computes the neighbor tile (proceeding, current or next) offset position using parameters k and z for fetching adjacent voxels. A computation step 242 defines start and end coordinates of an effective region in which adjacent voxels are fetched for the subject voxel. An update step 250 then calls GPU functions for updating voxel status. At the completion of the update process, a display step 260 displays the updated volume image.

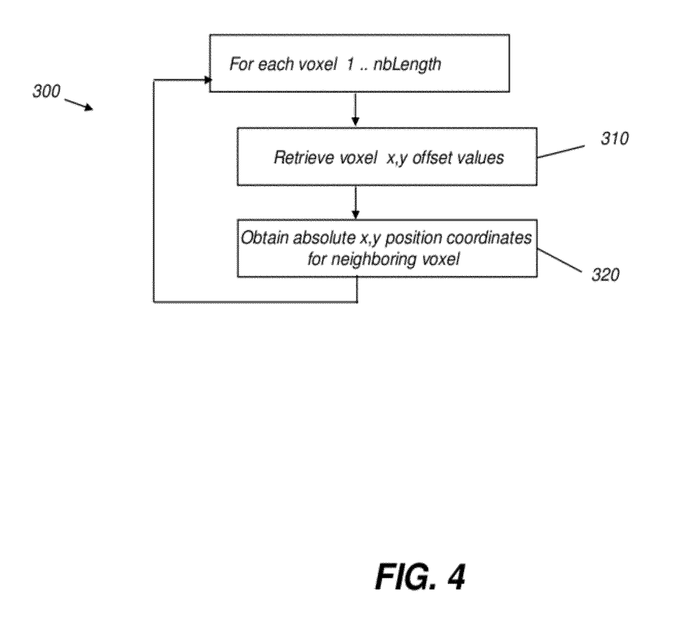

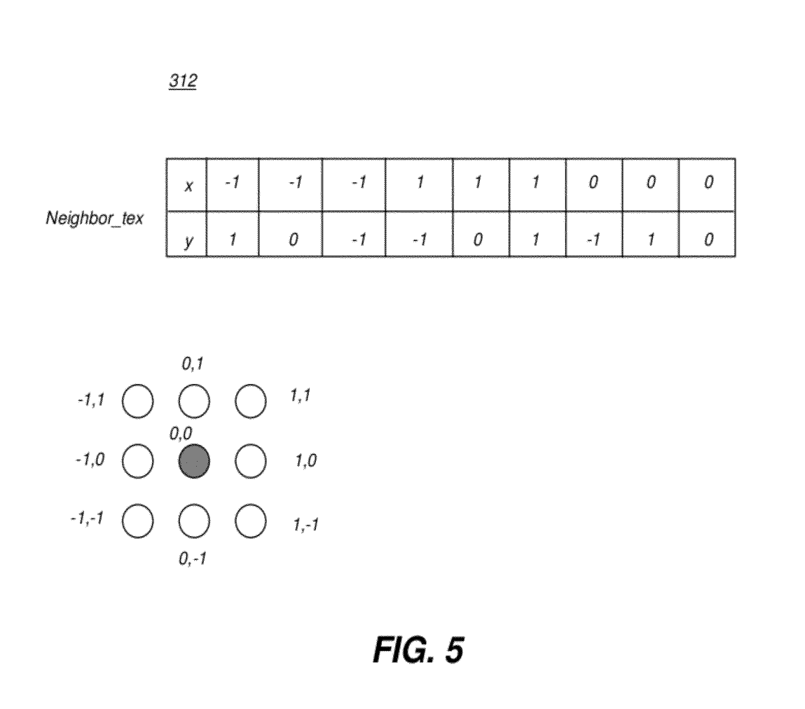

The logic flow diagram of FIG. 4 shows the voxel addressing sequence for neighbor-order rendering for each individual voxel 50 using the mapping of FIG. 2B, according to an embodiment of the present invention. A loop 300 executes for each neighboring voxel. Using the arrangement described previously with respect to FIG. 1B, the value nbLength equals 27, one for each of the neighboring voxels shown as 52 and one for voxel 50 itself. The 27 voxels in this example are from three layers, 9 voxels from the preceding neighborhood layer, 9 voxels from the current neighborhood layer, and 9 voxels from the next neighborhood layer. An offset retrieval step 310 retrieves the nine x and y offset values. These are stored as shown in the example of FIG. 5, in a texture 312. Absolute x- and y-position coordinates for each neighboring voxel are then obtained using the x and y offset values stored in a vector in a coordinate retrieval step 320. Coordinates for neighboring voxels are then simply obtained by adding the current voxel x,y coordinates to the x and y offset values.

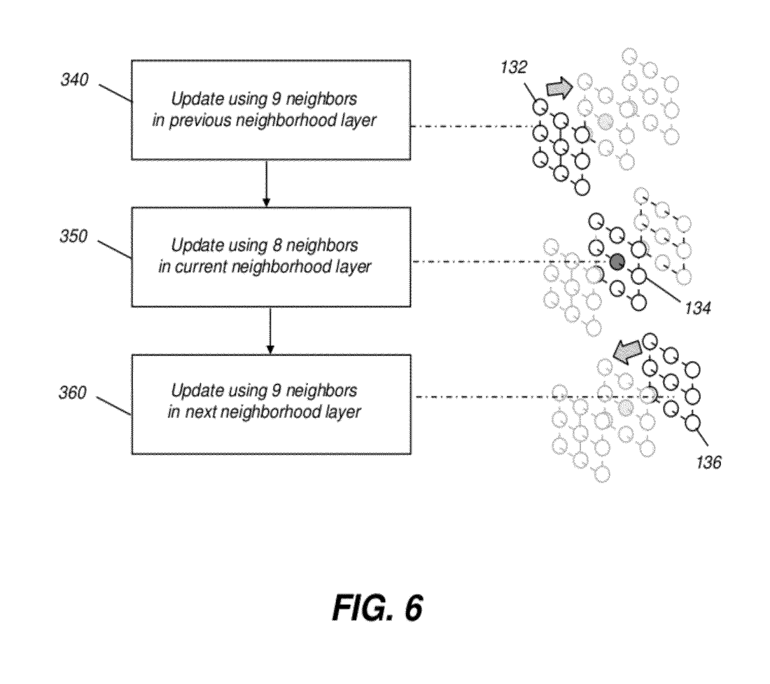

The block diagram of FIG. 6 shows three update steps 340, 350, and 360 for a voxel in graphic form. In a first update step 340, the voxel is processed using the 9 adjacent neighbor voxels in preceding neighborhood layer 132. In a second update step 350, the voxel is process using the 8 adjacent neighbor voxels in current neighborhood layer 134. In a third update step 360, the voxel is processed using the 9 adjacent neighbor voxels in next neighborhood layer 136. It should be noted that fewer than 8 voxels can be used in the currently neighborhood layer 134 and fewer than 9 from each of the adjacent layers 132 and 136.

This neighbor-order rendering approach is applied to voxels in all valid tiles in the flat volume, one at a time. By way of example, the GrowCut algorithm employs five flat volumes (2D textures): one intensity texture, two label textures and two strength textures. All these 2D textures have the same basic tile arrangement.

As described with reference to FIGS. 2C-2F, not all voxels are located between preceding and next slices, such as voxels on the border of the volume image. For such voxels, the neighborhood may extend only one slice in a particular direction, since additional voxel data is not available in the alternate direction. In such a case, the neighborhood consists of voxels in the same tile as the selected voxel and in one neighboring tile.

Those skilled in the art can appreciate that the neighbor-order rendering approach described herein can be generalized for applications in which a voxel has a neighborhood of some size other than 3×3×3. In such a case, for the exemplary GrowCut algorithm, a voxel's status (strength and label values) is updated based on its neighbors' status (strength and label values) in a plurality of steps by splitting its neighborhood into a plurality two dimensional neighborhood layers (or, simply, layers), namely, preceding or previous layers, current layer, and following layers residing in the preceding tiles, current tile and following tiles respectively.

Convergence verification is done by occlusion query. Two 2D label textures are compared and voxels in corresponding positions in two textures are discarded if they have identical label values. The occlusion query returns the number of remaining voxels in a label texture. The GrowCut evolution process (iteration) is terminated if the number returned is zero, which means that propagation process has converged.

The above design is a locally-parallel strategy, meaning that all voxels in a tile in a flat volume are processed simultaneously while tiles themselves in the flat volume are processed sequentially.

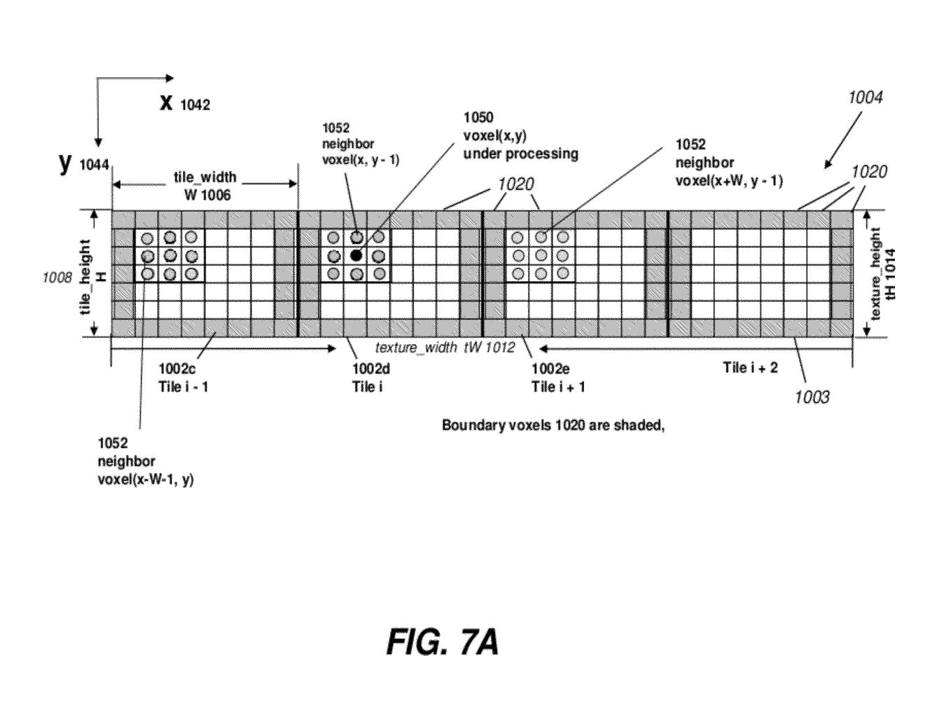

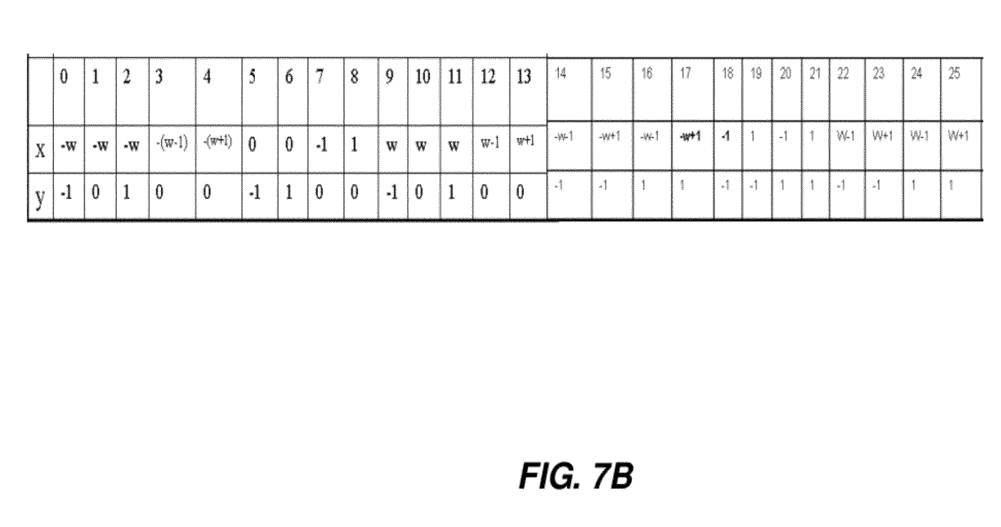

An alternate embodiment using globally-parallel processing strategy of the present invention is described with respect to FIGS. 7A and 7B. The data for a 3D volume is mapped to a flat volume 1004 that contains one row of tiles, each tile corresponding to one slice in the original 3D volume. An exemplary one-row flat volume is illustrated in FIG. 7A where four exemplary tiles 1002c, 1002d, 1002e, and 1003 are shown.

In the one-row flat volume or 2D texture of FIG. 7A, dimensions m_tileWidth (W 1006) and m_tileHeight (H 1008) are shown for tile 1002c. A texture width 1012 is shown as m_texWidth and is equal to:

m_texWidth=(m_tilelWidth)*(m_tileCol)=W*(m_tileCol)

wherein m_tileCol is the number of tiles (slices in a row). In the current example, m_tileCol=4.

A texture height 1014 is shown as m_texHeight. The texture height 1014, denoted m_texHeight, equals:

m_texHeight=(m_volHeight)*(m_tileRow)=H

wherein m_tileRow is the number of rows of tiles in the 2D texture presentation. In the current example, m_tileRow=1.

As shown in FIG. 7A, there is an x coordinate 1042 and y coordinate 1044 that provide the coordinate axis system for the 2D texture 1004.

There is shown an exemplary voxel(x,y) 1050 under processing for being updated using information from neighboring voxels. With this one-row flat volume configuration, each neighbor of voxel(x,y) 1050 in tile 1002d can be readily located with a corresponding coordinate offset. For example. neighbor voxel(x+W, y−1) 1052 in tile 1002e with an x coordinate offset by W and a y coordinate offset by −1. For neighbor voxel(x−W−1, y) in tile 1002c, the x offset is −W−1; the y offset is 0.

In the example of FIGS. 7A and 7B, voxel 1050 has 26 neighbors, using the basic arrangement described with respect to FIG. 6. A table 1062 in FIG. 7B shows relative x and y coordinate offset values to be used in parallel processing of a 3D volume with an exemplary CUDA implementation using this arrangement. By way of example, columns 18-21 in table 1062 give relative coordinates for the four corner neighbor voxels in tile 1002d. Columns 14-17 in table 1062 give relative coordinates for the four corner neighbor voxels in tile 1002c.

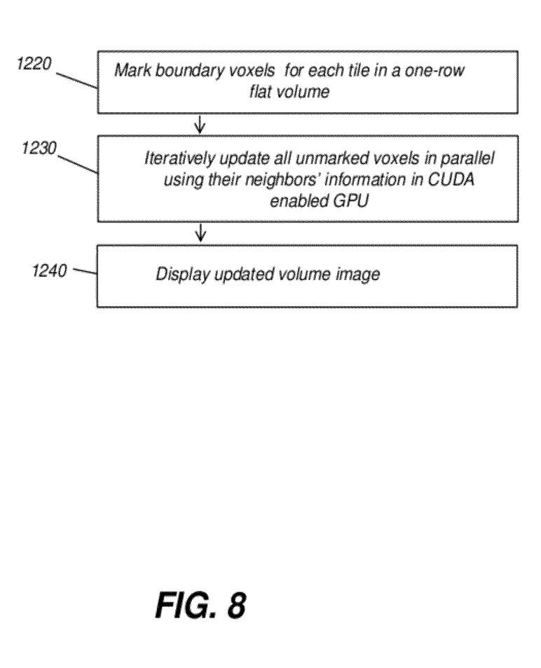

FIG. 8 highlights the major steps of parallel processing the one-row flat volume in the present invention. In a boundary marking step 1220, all boundary voxels (grids shaded in gray in FIG. 7A) 1020 of each tile in the one-row flat volume are marked as shown in FIG. 7A. Voxels marked as voxels 1020 are ignored in this exemplary CUDA based computation. In an update step 1230, unmarked voxels are updated iteratively in parallel in the CUDA enabled GPU. For each updated voxel, the data used for the update processing includes information from its corresponding neighbor voxels. In a display step 1240, the updated volume image is displayed for viewing and verification.

In CUDA implementation, the one-row flat volume, shown as flat volume 1004 in FIG. 7A, can be assigned to a CUDA array or a pitch linear array in the global memory used by the GPU. The CUDA array or the pitch linear array is then bound with a CUDA texture for fast memory accessing. The neighbor offset values can be stored in a CUDA shared memory for fast retrieval. Each voxel in the one-row flat volume is processed by a thread in a CUDA kernel. A thread corresponding to a marked boundary voxel 1020 will be skipped in parallel processing.

Continuing with the GrowCut example, processing of the volume image uses five one-row flat volumes assigned as: label one-row flat volume L; label buffer one-row flat volume L_{B}; strength one-row flat volume S; strength buffer one-row flat volume S_{B}; and intensity one-row flat volume C.

For a volume containing K slices, the layout of the one-row flat volume can be represented in a single-row matrix form, using label volume L as an example, as: L=[L¹ L² . . . L^{K}]. where L^{k} is a slice in the volume. The same format is applicable to all the other volumes.

The GrowCut implemented in CUDA can be described by the following pseudo code.

```
continue = true
while(continue)
    for ∀c_{(x,y)}^{k} |k ε [2,..., K −1]; (x, y) ε [unmarked _locations]
        [l_{(x,y)}_{_{B}} ,s_{(x,y)}_{_{B}} ] [symbol]   φ(l_{(x,y)}^{k},s_{(x,y)}^{k},c_{(x,y)}^{k})
    end
    if (diff (L,L_{B}) < ε
        continue = false
    else
        L = L_{B}
        S = S_{B}
    end
end
```

For an image voxel c_{(x,y)}^{k} residing in an unmarked position (x,y) in any tiles except the first tile (k=1) and the last tile (k=K), its label l_{(x,y)}^{k} and strength s_{(x,y)}^{k} are updated in a function call of φ( ) as described in Vezhnevets' paper. In function φ, neighbors of c_{(x,y)}^{k}, l_{(x,y)}^{k}, and s_{(x,y)}^{k} are used. In CUDA implementation, neighbors' offset values, shown in Table 1062 in FIG. 7B, are stored in CUDA-shared memory for fast retrieval. Each (x,y) location, either with a marked or unmarked voxel, is linked with one CUDA thread. Function call φ ( ) is built in a CUDA kernel. The same kernel is applied to all assigned threads. All assigned threads are updated simultaneously.

Convergence verification, with diff( ) is performed for every iteration for the while loop described above, so that L_{B} and current textures L are compared to verify if they are exactly the same or if the difference is within a small value of ε as shown in the above algorithm.

It can be appreciated that the data mapping and addressing scheme of the present invention, using the GPU flat volume representation, facilitates addressing of voxels in adjacent slices, thus simplifying the update processing task for each voxel. Using the GPU to perform this function provides significant advantages for processing throughput, helping to speed execution of the GrowCut algorithm and similar processing.

The present invention is described as a method. However, in another preferred embodiment, the present invention comprises a computer program product for image linear structure detection in medical applications in accordance with the method described. In describing the present invention, it should be apparent that the computer program of the present invention can be utilized by any well-known computer system, such as the personal computer. However, many other types of computer systems can be used to execute the computer program of the present invention.

It will be understood that the computer program product of the present invention may make use of image manipulation algorithms and processes that are well known. Accordingly, the present description is directed in particular to those algorithms and processes forming part of, or cooperating more directly with, the method of the present invention. Such algorithms and processes are conventional and within the ordinary skill in the image processing art. Additional aspects of such algorithms and systems, and hardware and/or software for producing and otherwise processing the images or co-operating with the computer program product of the present invention, are not specifically shown or described herein and may be selected from such algorithms, systems, hardware, components and elements known in the art.

A computer program product for executing the method of the present invention, such as computer 158 in FIG. 1C, may include one or more storage media, for example; magnetic storage media such as magnetic disk or tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention. The computer of the present invention has both a central processing unit (CPU) and a Graphics Processing Unit (GPU) that cooperate to provide the volume processing functions described herein.

It will be appreciated that variations and modifications can be effected by a person of ordinary skill in the art without departing from the scope of the invention. The subject matter of the present invention relates to digital image processing and computer vision technologies, which is understood to mean technologies that digitally process a digital image to recognize and thereby assign useful meaning to human understandable objects, attributes or conditions, and then to utilize the results obtained in the further processing of the digital image.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed is:

1. A method for processing digital volume image data, the method executed at least in part on a computer that has an associated graphics processing unit, comprising:
ordering the digital volume image data as a stack of two-dimensional image slices, each image slice containing a plurality of voxels;
forming a 1:1 mapping of each of the slices, in sequential order, to a corresponding tile in a digital one-row flat volume in a global memory of the graphics processing unit;
defining, for each voxel of a plurality of voxels in the digital flat volume, a neighborhood that comprises, relative to said each voxel, four or more adjacent voxels that are within the corresponding tile of said each voxel, and one or more adjacent voxels that are within the preceding tile, and one or more adjacent voxels that are within the next tile;
updating said each voxel according to information stored for the adjacent voxels in the defined neighborhood for said each voxel to form a rendered volume image; and
displaying the updated rendered volume image.

2. The method of claim 1 wherein defining the neighborhood comprises addressing each adjacent voxel using an x-y offset that gives the position of the adjacent voxel within the corresponding tile.

3. The method of claim 1 wherein the digital flat volume is a one-row tile flat volume.

4. The method of claim 1 further comprising identifying one or more boundary voxels in at least one tile that are not updated according to the defined neighborhood.

5. The method of claim 1 wherein the digital flat volume is a texture of the graphics processing unit.

6. The method of claim 1 wherein forming the rendered volume image further comprises performing image segmentation on the flat volume image.

7. The method of claim 1 wherein at least two voxels are updated simultaneously.

8. The method of claim 1 wherein the digital volume image is a computed tomography image.

9. The method of claim 1 wherein updating comprises applying a filter to the digital volume image data.

10. The method of claim 1 wherein updating comprises applying segmentation to the digital volume image data.

11. A method for processing digital volume image data, the method executed at least in part on a computer that has an associated graphics processing unit, comprising:
ordering the digital volume image data as a stack of two-dimensional image slices, each slice containing a plurality of voxels;
forming a 1:1 mapping of each of the slices, in sequential order, to a corresponding tile in a digital one-row flat volume in a global memory of the graphics processing unit;
defining, for each voxel of a plurality of voxels in the digital flat volume, a neighborhood that comprises, relative to said each voxel, eight adjacent voxels that are within the corresponding tile of said each voxel, nine adjacent voxels that are within the preceding tile, and nine adjacent voxels that are within the next tile;
updating said each voxel according to information stored for the adjacent voxels in the defined neighborhood for said each voxel to form a rendered volume image; and
displaying the updated rendered volume image.

12. The method of claim 11 wherein defining the neighborhood comprises addressing each adjacent voxel using an x-y offset that gives the position of the adjacent voxel within the corresponding tile.

13. The method of claim 11 wherein the digital flat volume is a one-row tile flat volume.

14. The method of claim 11 further comprising identifying one or more boundary voxels in at least one tile that are not updated according to the defined neighborhood.

15. The method of claim 11 wherein the digital flat volume is a texture of the graphics processing unit.

16. The method of claim 11 wherein forming the rendered volume image further comprises performing image segmentation on the flat volume image.

17. The method of claim 11 wherein at least two voxels are updated simultaneously.

18. The method of claim 11 wherein the digital volume image is a computed tomography image.

19. The method of claim 11 wherein updating comprises applying a filter to the digital volume image data.
